(19) United States
(12) Patent Application Publication
(10) Pub. No.: US 2006/0178172 A1
(43) Pub. Date: Aug. 10, 2006

(54) Portable multi-function cooler with AM/FM radio

(76) Inventor: Se Kit Yuen, Hong Kong (CN)

Correspondence Address: ARTHUR KING MA, 1030 CORONADO DRIVE, ARCADIA, CA, 91007, US

(21) Appl. No.: 11/085,409

(22) Filed: Mar. 21, 2005

(30) Foreign Application Priority Data
Feb. 8, 2005 (HK) 05101064.4

(51) Int. Cl. H04M 1/00

(52) U.S. Cl. 455/575.1

(57) ABSTRACT

The present invention relates to an environmental portable multi function cooler with AM/FM radio. It has a retractable adjustable shoulder belt for the convenience of user. Said cooler with radio also has a cup holder, which installs next to a storage bin in parallel line, providing user with a stabilized holder for cup or soda can. Said cup holder has protective covers, which provide relative movement between position one and position two. At position one, protective cover of cup holder lies in the same plane as outer surface of the storage bin to provide the user with a retractable cup holder. At position two, protective cover opens to provide the user with a fixed holder for water cup or can. Said portable multi function cooler with AM/FM radio has a bad on its side for the convenience of the user to place little things like pen, snack and soda, etc.

### BACKGROUND OF SAID PRESENT INVENTION

1. Field of Invention

Said present invention relates to a portable cooler and more particularly relates to a portable cooler with AM/FM radio.

2. Description of Related Arts

### SUMMARY OF SAID PRESENT INVENTION

This new practical invention of environmental portable multi-function cooler with AM/FM radio involves a fridge-style storage that uses more than municipal power supply.

This new practical invention proposes an updated and improved design of fridge of its kind. This invention of environmental portable multi-function cooler with AM/FM radio consists of a rectangular body, a cover of said body, a cup holder and a group of electronic circuit. Said aforesaid cover connects to one end of said rectangular body and can rotate 100 degrees freely to provide said user with an appropriate valve, which closes or opens as food is placed inside said environmental portable multi-function cooler with AM/FM radio. Said aforesaid cup holder is affixed and fastened to said above end of said rectangular body. Said protective cover of said cup holder makes relative movements between position one and position two. At position one, said protective cover lines within said same surface with said outer surface of said storage bin to provide said user with a retractable cup holder. At position two, said protective cover of said cup holder opens to provide said user with a stable cup holder for placing water cup or can.

Said aforesaid electronic circuit system is installed at said other side of said rectangular body with a protective cover to prevent foreign contact or damages to said circuit system. Said circuit system is mainly connected with external power, including city power and vehicle power. Then said circuit system will generate cooling or heating to keep said food in said storage at desired temperature.

Said rectangular body has a bad on said side for said convenience of said user to place little things such as pen, snack and soda, etc.

Said radio is detachable for independent carriage and usage, providing said user with convenience to receive radio signals and carry lights at any position.

### BRIEF DESCRIPTION OF SAID DRAWINGS

FIG. 1 is a side view of said present invention.

FIG. 2 is a side sectional view thereof.

FIG. 3 is an underneath view thereof.

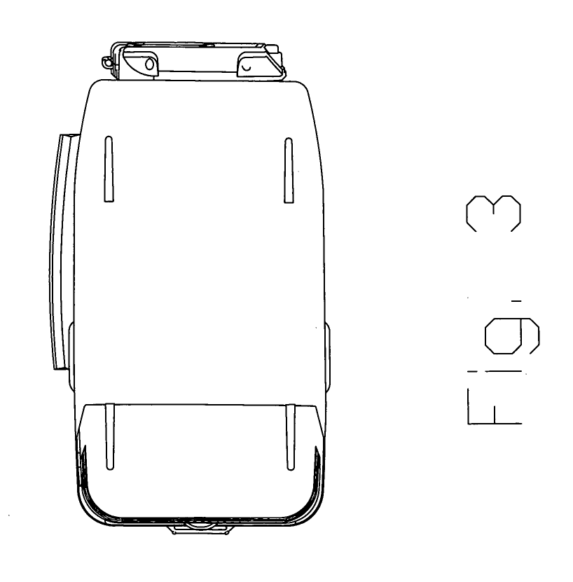

FIG. 4 is a plan view thereof.

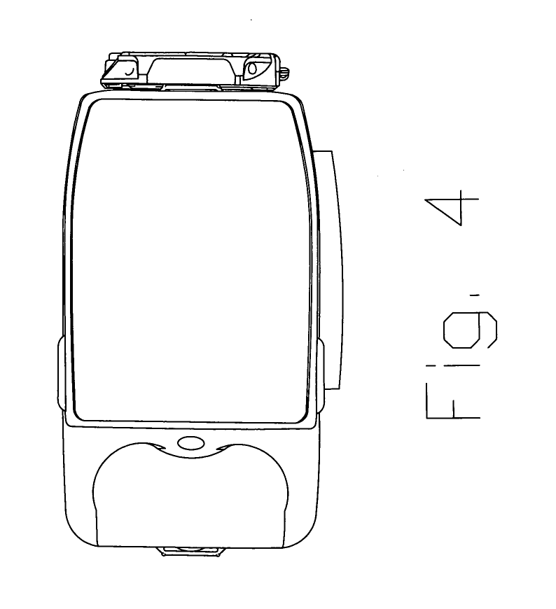

FIG. 5 is a front view thereof.

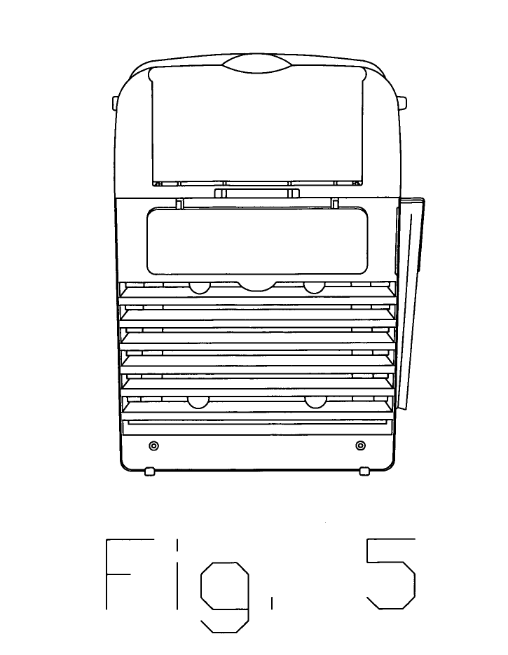

FIG. 6 is a rear view thereof.

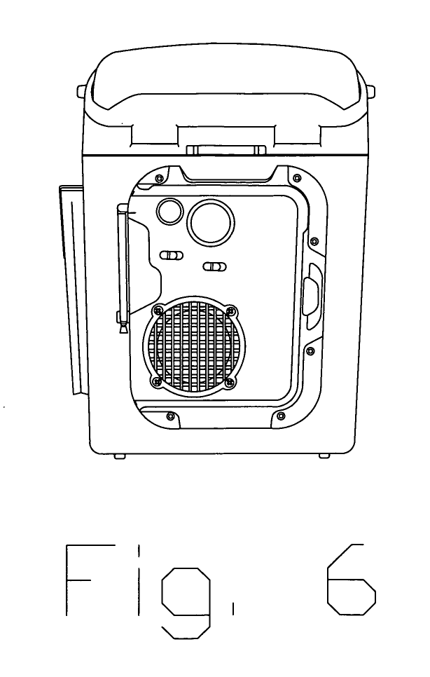

FIG. 7 is another side view with top opened thereof.

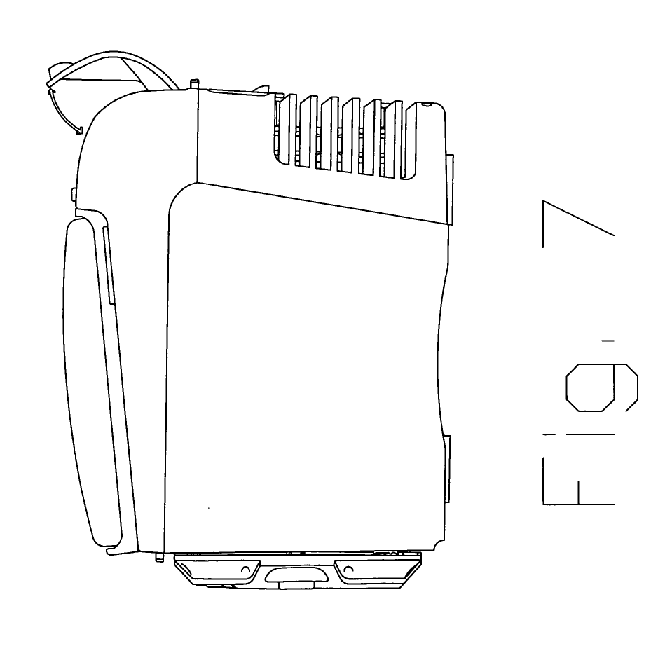

FIG. 8 is another side view thereof.

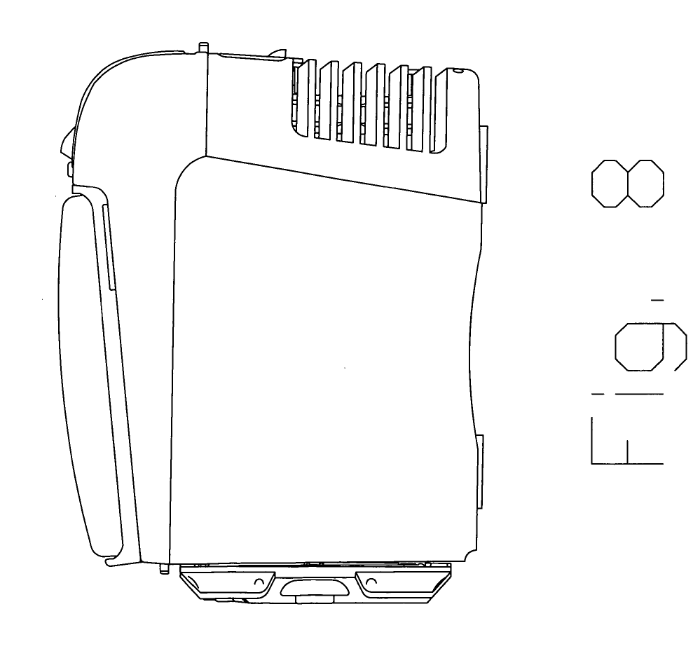

FIG. 9 is a front view of radio component thereof.

FIG. 10 is a front assembly view of radio component thereof.

FIG. 11 is a rear view of radio component thereof.

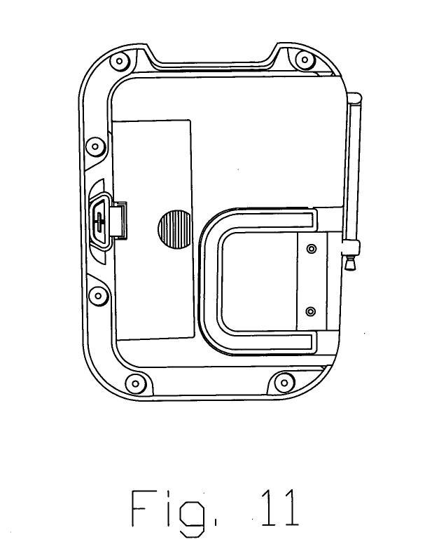

FIG. 12 showing a battery entry for radio component thereof.

### DETAILED DESCRIPTION OF SAID PREFERRED EMBODIMENT

Said present invention of environmental portable multi-function cooler with AM/FM radio consists of a usually rectangular body (1), inside which there installed an aluminum plate (2), which is encircled by thermal component (3). As said top component (4) is fastened to one end of said body (1), said aluminum plate (2) and thermal component (3) are hidden within said body (1). Said top component (4) has a rectangular window (5) inside to form an entrance of this environmental portable multi-function cooler with AM/FM radio.

There is a flexible parabolic door cover (6), said surface of which is covered by leather. There is a panel component (7) under said door cover (6), while a thermal component (10) lies between said door cover (6) and said panel component (7). Said panel component (7) is connected to side body (1) at one end and installs a door lock plate (8) at other end. It is installed within a central rectangular pit of said panel component (7) by using a sealing washer (9). It is obvious that said panel component (7) is an appropriate valve, an entrance to said environmental portable multi-function cooler with AM/FM radio when opens or closes. When a valve closes, door lock plate (8) at one end of said panel component (7) will be fastened by a lock (29) without being able to move freely.

A sealing washer (9) presses against a central rectangular window (5) of top component (4) to prevent temperature and air within said environmental portable multi-function cooler with AM/FM radio from leaking out.

Both front and rear ends of said body (1) have shoulder buckle (11).

As shown in all figures, an electronic circuit system (12) consists of an aluminum component (13), cooling and heating component (14), radiator (15), fan (16), integrated circuit (17), switch button (18), indicator light (19) and external power line (20). As an aluminum component (13) is fastened to an aluminum plate (2), said electronic circuit system (12) will be activated right away upon a connection with external power line (20) and said switch (18) on by user. Then a cooling and heating component (14) generates coolant or heat, which are then transmitted upon said aluminum plate (2) via said aluminum component (13). Due to said thermal component (3) between said aluminum plate (2) and said body (1), said coolant or heat generated by said aluminum plate (2) can be maintained within said environmental portable multi-function cooler with AM/FM radio. On another hand, said heat in a protective cover is driven away out of said body (1) via a long gap (22) by a power of a fan (16). Said door cover (24) of a protective shield (21) is connected to an upper end of inside notch, and can be opened to take out an external power line (20).

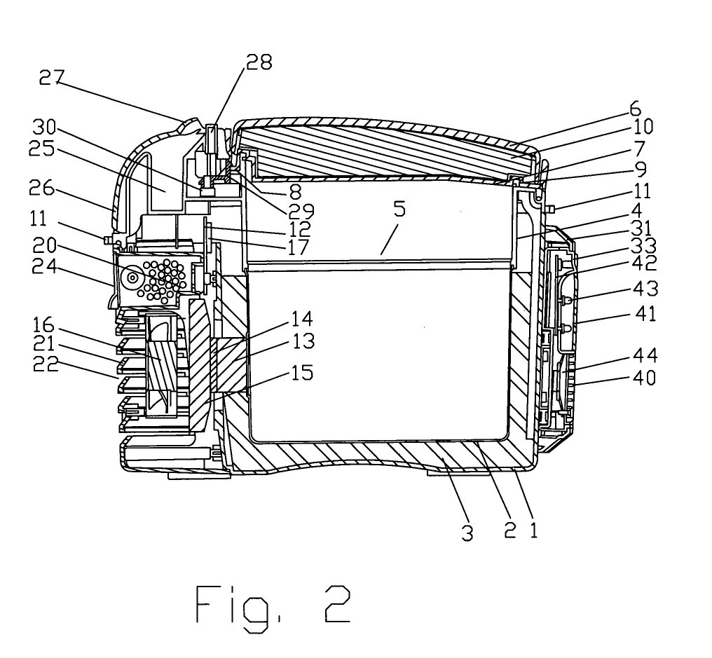

As shown in FIG. 2, a cup holder (25) is fastened to an upper end of said body (1), while said cup holder protective cover (26) is connected to said other side of said body (1) in a flexible manner. There is a flange (27) in front of said cup holder protective cover (26), which can be pulled up to open said protective cover (26) of said cup holder, then soda can may be placed within said cup holder (25).

As shown in FIG. 2, there is a pressing button (28) on said top of said body (1). Said pressing button (28) lies next to a lock component (29) at said bottom. Within said lock component (29) there hides a slingshot (30). Said aforesaid lock component (29) is attached to said door lock plate (8) of said panel component (7). It is obvious that as said user presses said pressing button (28), said lock component (29) will be detached from said door lock plate (8) of said panel component (7), then said panel component (7) can be opened.

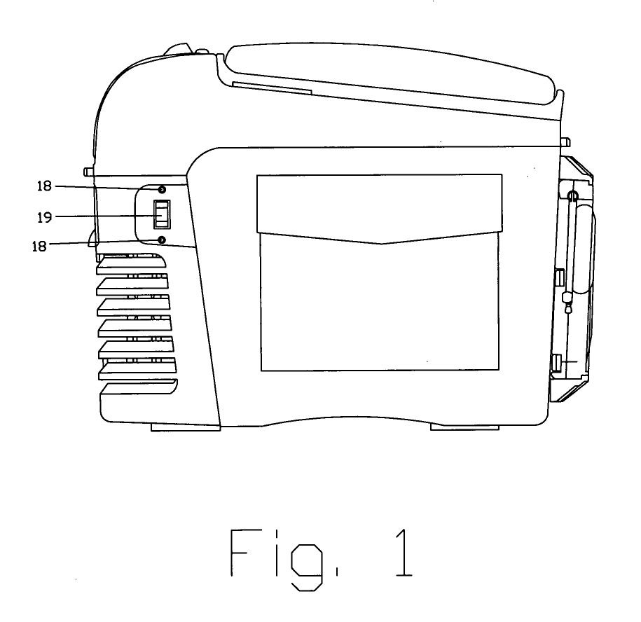

As shown in FIG. 1, said body (1) has at least one bag (23) made of flexible material at one side for said user to place little things such as pen, snack and soda, etc.

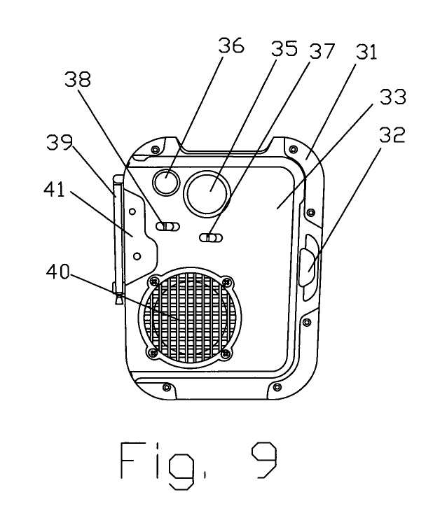

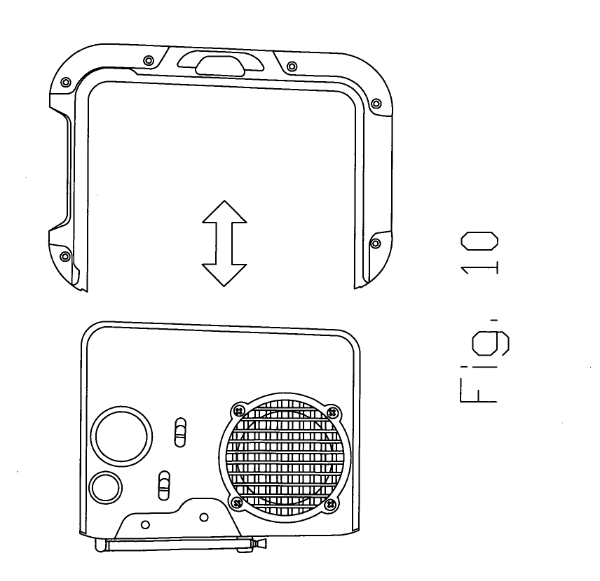

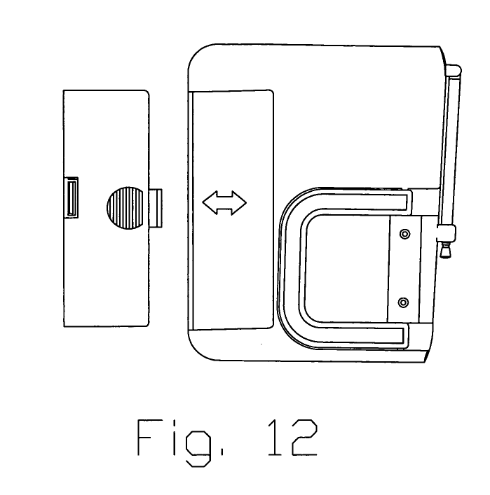

There is a radio assembly at said rear end of said body (1). As shown in FIG. 9, said radio assembly consists of a radio frame (31), a pressing button (32), and a radio body (33). Said radio frame (31) is fastened to said rear surface of said body (1). As shown in FIG. 10, said user presses down said button (32) to separate said radio body (33) from said radio frame (31) as an independent component for said convenience of carriage by said user. As shown in FIGS. 12 and 13, said handle bar (34) on said radio body (33) can be rolled and hidden inside said radio body (33), or function as a handler for said user once rolled to reach out of said radio body (33).

As shown in FIG. 9, on said surface of said aforesaid radio body (33), there is a station selector dial (35), a volume controller antenna (39), a speaker screen (40) and an LED light shield (41) made of transparent materials. As shown in FIG. 2, inside said aforesaid radio body (33), there is a set of electronic circuit board (42), two super-light LED bulbs (43) under said LED light shield (41), and one speaker (44) fastened to said inner surface of said speaker screen (40). As shown in FIG. 12, at said rear radio body (33), there is a battery door cover (45), which may be pulled out to place batteries inside said radio body (33) as power.

This new practical invention of environmental portable multi-function cooler with AM/FM radio provides retractable cup holder (25) as well as convenience for carriage with hands.

This new practical invention of environmental portable multi-function cooler with AM/FM radio can generate coolant and heating, and provide effective insulation and constant temperature for multipurpose usage in vehicle, vessels, outdoor activities and daily life. It is also easy to carry with hands.

Said radio of this new practical environmental portable multi-function cooler with AM/FM radio can be installed in a movable manner within said radio frame (31) at said rear end of said environmental portable multi-function cooler with AM/FM radio, or used and carried independently.

What is claimed is:

1. A portable multi-function cooler with AM/FM radio comprises:
a three-dimensional cylinder housing body pre-determined size and sharp inner chamber provided, and
aluminum plates are installed at both ends of said chambers thereof as insulating means, and
a plurality of an integrated circuit installed in between said body and circuit unit, and
a plurality of coolant, radiator, and
a plurality of fan and
a plurality of external power connector, and
a plurality of valve connecting to said body having ability to shut down a door of an inner chamber of storage bin; and
a plurality of cup holder connecting to said body and
a plurality of radio receiving transmitters having ability to receive AM and FM signals.

2. A portable multi-function cooler with AM/FM radio as recited in claim 1, wherein said cooler is further comprises a plurality of storage bags allowing storage of items.

3. A portable multi-function cooler with AM/FM radio as recited in claim 1, wherein said cooler is further comprises:
at least one fan installed within said circuit, and
at least one radiator connecting said circuit and said buttons, and
at least one switch button and one external power plug.

4. A portable multi-function cooler with AM/FM radio as recited in claim 1, wherein said cooler is further comprises:
a three-dimensional cylinder housing body pre-determined size and sharp inner chamber provided, and
aluminum plates are installed at both ends of said chambers thereof as insulating means, and
a plurality of an integrated circuit installed in between said body and circuit unit, and
a plurality of coolant, radiator, and
a plurality of fan and
a plurality of external power connector, and
a plurality of valve connecting to said body having ability to shut down a door of an inner chamber of storage bin; and
a plurality of cup holder connecting to said body and
a plurality of radio receiving transmitters having ability to receive AM and FM signals; and
at least one fan installed within said circuit, and
at least one radiator connecting said circuit and said buttons, and
at least one switch button and one external power plug.

5. A portable multi-function cooler with AM/FM radio as recited in claim 1, wherein said cooler is further comprises:
a cup holder installed of said body is featured by its protective cover's ability to make relative movement between position one and position two.

6. A portable multi-function cooler with AM/FM radio as recited in claim 1, wherein said cooler is having a radio components, said radio components further comprises:
a plurality of radio frame, and
a plurality of radio components are installed in a movable manner within the radio frame at the rear end of the environmental electronic fridge and radio.

7. A portable multi-function cooler with AM/FM radio as recited in claim 1, wherein said cooler is further comprises a radio frame and is fastened connection to the rear surface of the body.
